(19) United States
(12) Patent Application Publication
(10) Pub. No.: US 2023/0299446 A1
(43) Pub. Date: Sep. 21, 2023

(54) METHOD FOR PRODUCING A BATTERY

(71) Applicant: Prime Planet Energy & Solutions, Inc., Tokyo (JP)

(72) Inventors: Takeyuki OZAKI, Seto-shi (JP); Junwen BAI, Tokushima-shi (JP)

(21) Appl. No.: 18/079,873

(22) Filed: Dec. 13, 2022

(30) Foreign Application Priority Data
Mar. 17, 2022 (JP) 2022-042476

(51) Int. Cl. H01M 50/618

(52) U.S. Cl. CPC H01M 50/618

(57) ABSTRACT

A method for producing a battery includes discharging bubbles, which stick to an inner surface of an injection nozzle, to outside of an injection nozzle together with an electrolyte ejected from the injection nozzle by ejecting the electrolyte from the injection nozzle under atmospheric pressure before evacuating is performed.

### CROSS-REFERENCE TO RELATED APPLICATIONS

This application is based upon and claims the benefit of priority to Japanese Patent Application No. 2022-042476 filed on Mar. 17, 2022, the entire contents of which are incorporated herein by reference.

### BACKGROUND

### Technical field

The present disclosure relates to a method for producing a battery.

### Related Art

Japanese unexamined patent application publication No. 2020-184452 discloses a method for producing a battery provided with an electrode body and an electrolyte which are accommodated in a battery case. Specifically, in an evacuating step, an injection nozzle is inserted in the battery case accommodating the electrode body through a liquid inlet of the battery case, and the battery case whose interior is at atmospheric pressure is evacuated to create vacuum in the battery case. Concretely, when a chamber in which the battery case and others are placed is vacuumed, the interior of the battery case can be brought to a vacuum state. In a first vacuum liquid-injecting step, subsequently, the electrolyte is ejected from the injection nozzle at a first injection speed to inject a predetermined amount A of the electrolyte into the evacuated battery case. In a second vacuum liquid-injecting step, further, the electrolyte is ejected from the injection nozzle at a second injection speed slower than the first injection speed to inject a predetermined amount B of the electrolyte into the evacuated battery case.

After the end of the second vacuum liquid-injecting step, the interior of the battery case is returned to the atmospheric pressure. Concretely, when the chamber in which the battery case and others are placed is released to atmospheric pressure, the interior of the battery case can be brought to an atmospheric pressure state. Then, in a first atmospheric-pressure liquid-injecting step, the electrolyte is ejected from the injection nozzle at a third injection speed to inject a predetermined amount C of the electrolyte into the battery case whose interior is at atmospheric pressure. In a subsequent second atmospheric-pressure liquid-injecting step, the electrolyte is ejected from the injection nozzle at a fourth injection speed slower than the third injection speed to inject a predetermined amount D of the electrolyte into the battery case in the atmospheric pressure state. Accordingly, liquid injection into the battery case of the relevant battery is completed. Subsequently, a new battery is subjected to the foregoing series of processes.

### SUMMARY

### Technical Problems

In the above conventional method, incidentally, after the liquid injection on the battery case is terminated, the injection nozzle is held in the atmospheric pressure state with the electrolyte remaining in the injection nozzle until the evacuating step is newly started for liquid injection on another battery case. During this period, fine bubbles contained in the electrolyte remaining in the injection nozzle may collect on the inner surface of the injection nozzle, resulting in relatively large bubbles, which stick to the inner surface of the injection nozzle. Therefore, in the evacuating step for liquid injection on a new battery case, when the injection nozzle is inserted in the battery case through the liquid inlet of the battery case whose interior is at atmospheric pressure and then this battery case is evacuated, the bubbles sticking to the inner surface of the injection nozzle may expand out of the injection nozzle and rupture. This may cause resultant droplets of the electrolyte to scatter out of the battery case through the liquid inlet, thus wetting a part of the top surface of the battery case around the edge of the liquid inlet, i.e., an inlet circumferential edge portion on the top surface of the battery case. If this inlet circumferential edge portion on the top surface of the battery case is wetted with the electrolyte, a sealing failure could occur when the liquid inlet is sealed later with a sealing member. For instance, when the liquid inlet is sealed with a sealing member welded to the circumferential edge portion of the liquid inlet, a sealing failure could occur due to poor welding of the sealing member.

The present disclosure has been made to address the above problems and has a purpose to provide a method for producing a battery capable of “performing evacuating without causing bubbles sticking to an inner surface of an injection nozzle to expand out of the injection nozzle and further rupture, thus preventing resultant droplets from scattering out of a battery case through a liquid inlet and wetting an inlet circumferential edge portion on the top surface of the battery case”.

### Means of Solving the Problems

(1) To achieve the above-mentioned purpose, one aspect of the present disclosure provides a method for producing a battery provided with an electrode body and an electrolyte which are accommodated in a battery case, the method comprising: evacuating the battery case whose interior is at atmospheric pressure to create vacuum in the battery case accommodating the electrode body while a liquid injection nozzle is inserted in the battery case through a liquid inlet of the battery case; and vacuum-injecting the electrolyte into the battery case whose interior has been evacuated to the vacuum, by ejecting the electrolyte from the injection nozzle, wherein the method further comprises: under atmospheric pressure before the evacuating is performed, discharging bubbles, which stick to an inner surface of the injection nozzle, to outside of the injection nozzle together with an electrolyte ejected from the injection nozzle by ejecting the electrolyte from the injection nozzle.

The foregoing producing method includes the discharging in which the electrolyte is ejected from the injection nozzle before execution of the evacuating under atmospheric pressure, thereby discharging the bubbles sticking to the inner surface of the injection nozzle to the outside of the injection nozzle together with the electrolyte ejected from the injection nozzle. According to the above-described producing method, therefore, the evacuating can be performed after removal of the bubbles from the inner surface of the injection nozzle. In the evacuating, specifically, while the injection nozzle from which the bubbles having stuck to the inner surface have been removed remains inserted in the battery case through the liquid inlet, the battery case can be vacuumed. Consequently, the foregoing producing method can “perform the evacuating without causing the bubbles sticking to the inner surface of the injection nozzle to expand out of the injection nozzle and rupture, and thus prevent resultant droplets from scattering out of the battery case through the liquid inlet and wetting the inlet circumferential edge portion on the top surface of the battery case”.

In the discharging, the electrolyte ejected together with the bubbles from the injection nozzle may be injected into the battery case or may be discharged without being injected into the battery case. In the foregoing producing method, furthermore, after the electrolyte is injected into the battery case whose interior is under vacuum in the vacuum-injecting, the remaining electrolyte may be injected into the battery case whose interior is released to the atmospheric pressure. In other words, in the above-described producing method, a full amount of electrolyte to be supplied to the battery case may be injected into the vacuum-injecting or may be separately injected into the vacuum-injecting and an injecting process under atmospheric pressure.

(2) In the method for producing a battery, described in (1), furthermore, the discharging may include preliminarily injecting the electrolyte together with the bubbles into the battery case by ejecting the electrolyte from the injection nozzle while the injection nozzle is inserted, through the liquid inlet, in the battery case whose interior is at the atmospheric pressure.

In the foregoing producing method, the discharging is the preliminary injecting in which the electrolyte ejected together with the bubbles from the injection nozzle is injected into the battery case. Accordingly, this method is advantageous because any facilities for storing or collecting the discharged electrolyte are unnecessary, compared to a method wherein an electrolyte ejected together with bubbles from an injection nozzle is discharged without being injected into a battery case.

(3) In the method for producing a battery, described in (2), furthermore, the preliminarily injecting, the evacuating, and the vacuum-injecting may be continuously performed while the injection nozzle inserted in the battery case for the preliminarily injecting is kept inserted in the battery case.

In the foregoing producing method, the preliminarily injecting, the evacuating, and the vacuum-injecting are successively executed without moving the injection nozzle out of the battery case in the middle of those operations. Thus, those three operations can be performed quickly.

### BRIEF DESCRIPTION OF THE DRAWINGS

FIG. 1 is a cross-sectional view of a battery in an embodiment;

FIG. 2 is an explanatory diagram showing a liquid injection device in the embodiment;

FIG. 3 is a flowchart showing a flow of a method for producing a battery in the embodiment;

FIG. 4 is a flowchart showing a flow of a liquid injecting process in the embodiment;

FIG. 5 is an explanatory diagram showing an internal state of an injection nozzle before start of the liquid injecting process;

FIG. 6 is an explanatory diagram showing a bubble discharging step (a preliminary liquid-injecting step); and

FIG. 7 is a diagram showing a sealing process.

### DETAILED DESCRIPTION OF THE EXEMPLARY EMBODIMENTS

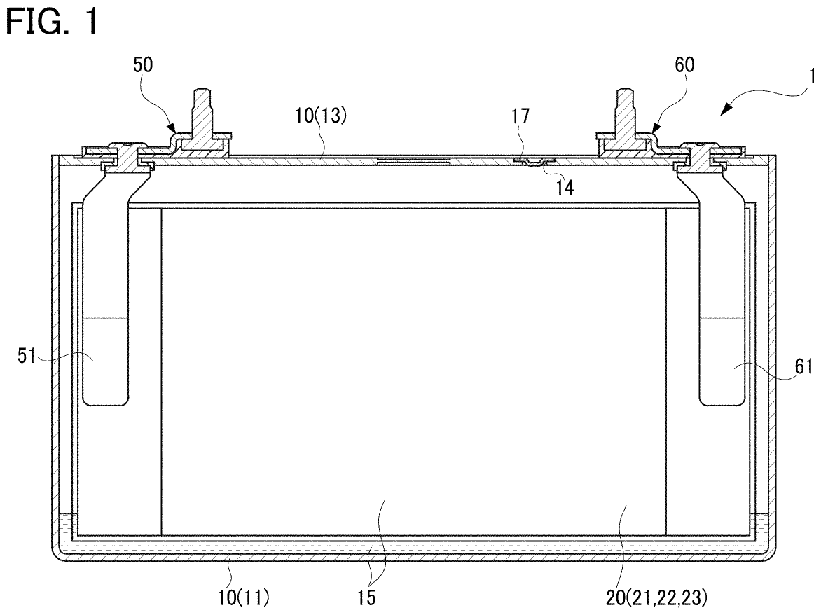

A detailed description of an embodiment of a method for producing a battery according to the present disclosure will now be given referring to the accompanying drawings. FIG. 1 is a cross-sectional view of a battery 1 in the present embodiment. The battery 1 is provided with a battery case 10, and an electrode body 20 and an electrolyte 15 which are accommodated in the battery case 10. A part of the electrolyte 15 is impregnated in the electrode body 20 and the remainder of the same accumulates on the bottom of the battery case 10. In the present embodiment, the electrolyte 15 used herein is a nonaqueous electrolytic solution in which a lithium salt (e.g., LiPF6, etc.) is dissolved in an organic solvent (e.g., ethylene carbonate, ethyl methyl carbonate, dimethyl carbonate, etc.).

The battery 1 is further provided with a positive terminal member 50 and a negative terminal member 60. The battery case 10 has a nearly rectangular parallelepiped shape and consists of a case body 11 and a lid 13. The lid 13 has a liquid inlet 14. In the battery 1 shown in the form of a completed product in FIG. 1, the liquid inlet 14 is hermetically sealed with a sealing member 17. The electrode body 20 is a laminated electrode body including positive electrode sheets 21 and negative electrode sheets 22 laminated with separators 23 interposed therebetween.

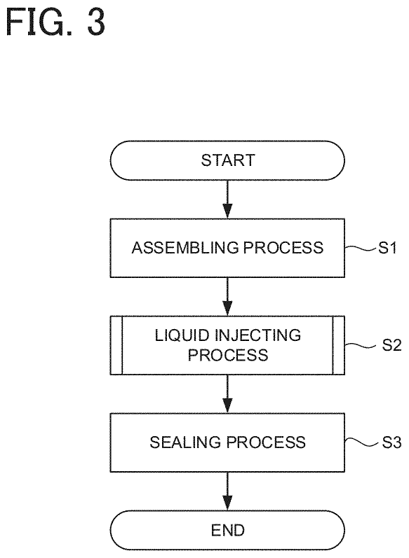

The method for producing a battery in the present embodiment will be described below. FIG. 3 is a flowchart showing a flow of this producing method of the battery 1. In step S1 (Assembling process), firstly, the components and parts of the battery 1 are assembled. Specifically, the positive terminal member 50 and the negative terminal member 60 are fixed to the lid 13. In this state, the positive terminal member 50 and the negative terminal member 60 extend through the lid 13 (see FIG. 1). A positive electrode connecting part 51 of the positive terminal member 50 is connected by welding to the positive electrode sheets 21 of the electrode body 20. Similarly, a negative electrode connecting part 61 of the negative terminal member 60 is connected by welding to the negative electrode sheets 22 of the electrode body 20. Then, the electrode body 20 is inserted in the case body 11 and further the opening of the case body 11 is closed with the lid 13. The lid 13 and the case body 11 are welded to each other along the opening edge of the case body 11. Thus, the battery case 10 with the lid 13 integrated with the case body 11 is produced. In this state, the liquid inlet 14 is not closed with the sealing member 17.

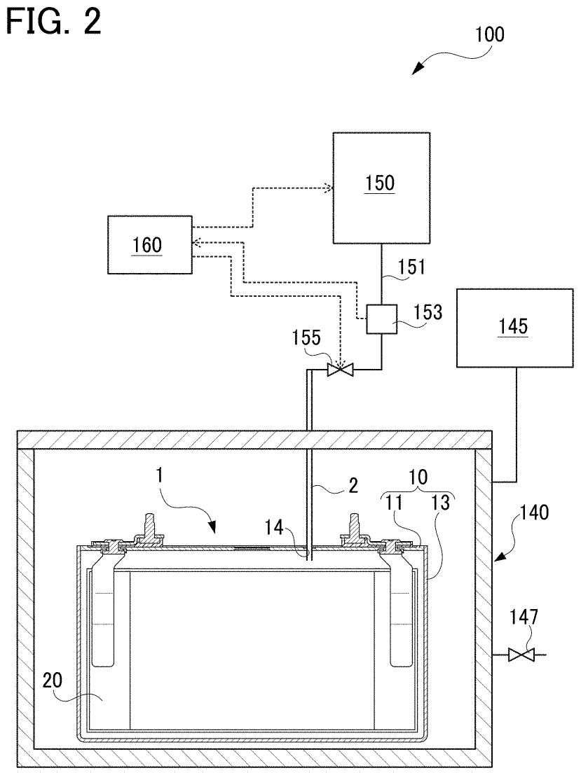

In subsequent step S2 (Liquid injecting process), the electrolyte 15 is injected into the battery case 10 accommodating therein the electrode body 20, through the liquid inlet 14 of the battery case 10. Herein, a liquid injection device 100 used in the present embodiment will be described. This liquid injection device 100 is provided with an injection nozzle 2, a vacuum chamber 140, an electrolyte tank 150, and a control unit 160, as shown in FIG. 2. The vacuum chamber 140 is connected to a vacuum pump 145 and an air release valve 147. The injection nozzle 2 is coupled to the electrolyte tank 150 through a liquid feed pipe 151. In this liquid feed pipe 151, a flowmeter 153 and a liquid injection valve 155 are provided.

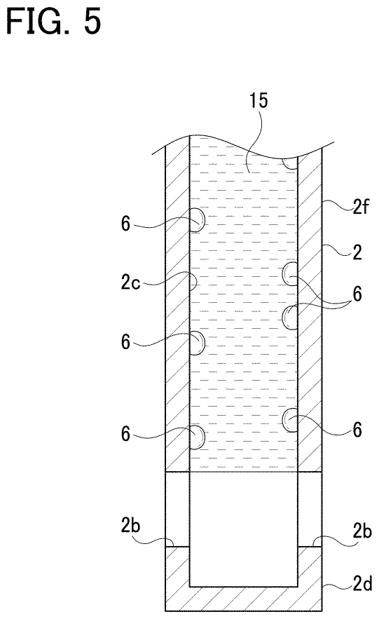

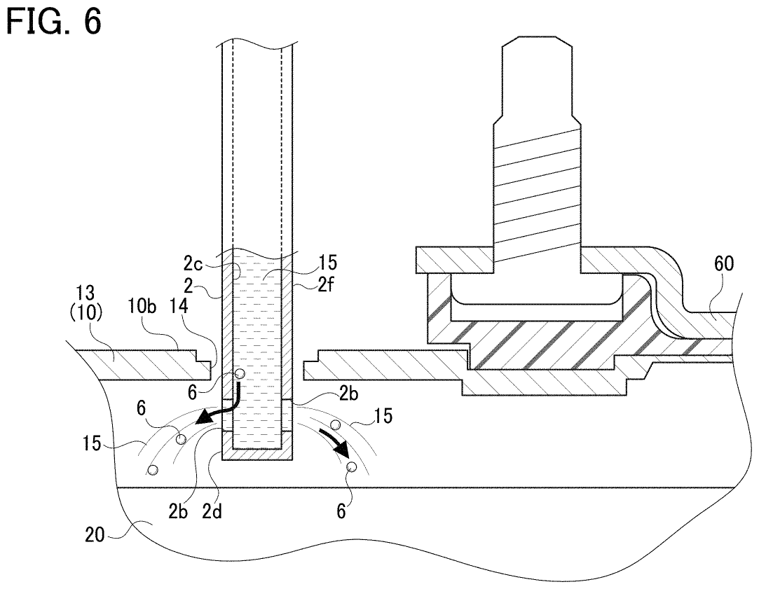

The injection nozzle 2 has a cylindrical shape having a peripheral wall 2f whose tip portion 2d is formed with two ejection ports 2b. These ejection ports 2b are arranged at opposed positions in the diametric direction of the injection nozzle 2 (see FIGS. 5 and 6). At the time of injecting the electrolyte 15 into the battery case 10, the tip portion 2d of the injection nozzle 2 is inserted in the battery case 10 so that the two ejection ports 2b are opposed in the width direction of the battery case 10, i.e., in the longitudinal direction of the electrode body 20, or the lateral direction in FIG. 2 (see FIG. 5). Accordingly, the electrolyte 15 is ejected through the ejection ports 2b of the injection nozzle 2 in the width direction of the battery case 10, in the longitudinal direction of the electrode body 20, or the lateral direction in FIGS. 2 and 5, and injected into the battery case 10.

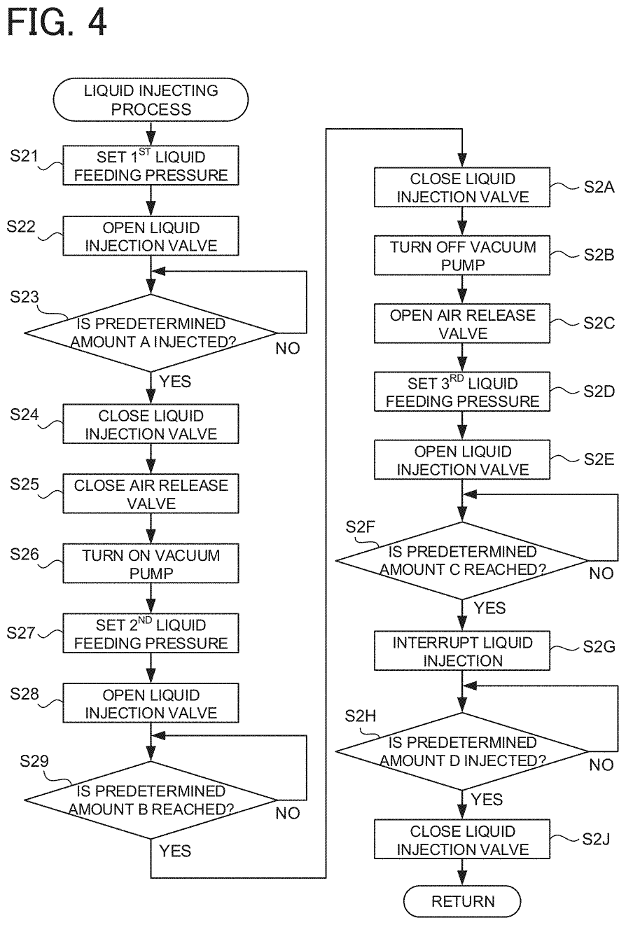

FIG. 4 is a flowchart showing a flow of the liquid injecting process. The battery case 10 with the electrode body 20 housed therein is put in the vacuum chamber 140 and then, for a preliminary liquid-injecting step, the injection nozzle 2 is inserted in the battery case 10 through the liquid inlet 14 of the battery case 10 (see FIG. 2). The internal space of the battery case 10 is communicated to the internal space of the vacuum chamber 140 through the liquid inlet 14. At that time, the liquid injection valve 155 is closed, the air release valve 147 is opened, and the vacuum pump 145 is not operated. Thus, the interior of the vacuum chamber 140 and the interior of the battery case 10 are at atmospheric pressure.

Incidentally, after the previous liquid injecting process on the battery case 10 is terminated, the injection nozzle 2 is held in the atmospheric pressure state with the electrolyte 15 remaining therein until the current liquid injecting process on another battery case 10 is newly started. Therefore, during this period, fine bubbles contained in the electrolyte 15 remaining in the injection nozzle 2 may collect on the inner surface 2c of the injection nozzle 2, resulting in relatively large bubbles 6, which stick to the inner surface 2c of the injection nozzle 2 (see FIG. 5). Under such circumstances, when the vacuum chamber 140 whose interior is at atmospheric pressure starts to be evacuated to vacuum, the following defects may occur. Specifically, the bubbles 6 sticking to the inner surface 2c of the injection nozzle 2 expand out of the injection nozzle 2 through the ejection ports 2b as the internal pressure of the vacuum chamber 140 decreases, and then the largely expanded bubbles 6 rupture, causing resultant droplets of the electrolyte 15 to scatter out of the battery case 10 through the liquid inlet 14, thus wetting a part of the top surface of the battery case 10 around the edge of the liquid inlet 14, which will be hereinafter referred to as an inlet circumferential edge portion 10b, with electrolyte 15.

To prevent the above-described defects, in the present embodiment, the following operations in steps S21 to S24 are performed. Specifically, while the interior of the vacuum chamber 140 and the interior of the battery case 10 are kept at atmospheric pressure, the control unit 160 sets, in step S21, a first liquid feeding pressure as the pressure for feeding the electrolyte 15 from the electrolyte tank 150. In step S22, the control unit 160 transmits a command to the liquid injection valve 155 to open, ejecting the electrolyte 15 from the injection nozzle 2 through the ejection ports 2b. The electrolyte 15 is thus ejected from the injection nozzle 2 through the ejection ports 2b while the interior of the vacuum chamber 140 and the interior of the battery case 10 are kept at atmospheric pressure without decreasing. This manner can discharge the bubbles 6 sticking to the inner surface 2c of the injection nozzle 2 out of the injection nozzle 2 together with the electrolyte 15 ejected from the ejection ports 2b of the injection nozzle 2 without causing the bubbles 6 to expand (see FIG. 6).

In step S22 in the present embodiment, while the tip portion 2d of the injection nozzle 2 is inserted in the battery case 10 through the liquid inlet 14 of the battery case 10, the electrolyte 15 ejected together with the bubbles 6 from the injection nozzle 2 is injected into the battery case 10 (see FIG. 6). Accordingly, the electrolyte 15 is injected into the battery case 10 at a first injection speed (a first flow rate) corresponding to the first liquid feeding pressure. In the present embodiment, this first injection speed is preferably set in a range of 6 to 20 g/min. This is because the electrolyte 15 when injected at the injection speed falling within this range can efficiently and appropriately push the bubbles 6 sticking to the inner surface 2c of the injection nozzle 2 out of the injection nozzle 2.

After opening the liquid injection valve 155 in step S22, the control unit 160 advances to step S23 to monitor output values of the flowmeter 153 and determine whether or not the supplied amount of the electrolyte 15 from the electrolyte tank 150 (hence, the ejected amount of the electrolyte 15 from the injection nozzle 2) reaches a predetermined amount A. In the present embodiment, the predetermined amount A is set in a range of 0.1 to 0.3 g. This is because the electrolyte in this range can appropriately discharge, or remove, the bubbles 6 sticking to the inner surface 2c of the injection nozzle 2, to the outside of the injection nozzle 2 together with the electrolyte 15, and also can shorten the time required for the liquid injecting process.

When it is determined in step S23 that the predetermined amount A is reached (S23: YES), the control unit 160 then transmits, in step S24, a command to the liquid injection valve 155 to close, stopping ejection of the electrolyte 15 from the injection nozzle 2. This can discharge the bubbles 6 sticking to the inner surface 2c of the injection nozzle 2 to the outside of the injection nozzle 2 together with the electrolyte 15. It is therefore possible to remove the bubbles 6 from the inner surface 2c of the injection nozzle 2. Further, the predetermined amount A of the electrolyte 15 can be injected into the battery case 10. The operations in steps S21 to S24 correspond to a bubble discharging step, which is one example of the discharging in the present disclosure, and also correspond to a preliminary liquid-injecting step, which is one example of the preliminarily injecting in the present disclosure.

In step S25, subsequently, the control unit 160 closes the air release valve 147. In step S26, the control unit 160 turns on the vacuum pump 145 to evacuate the vacuum chamber 140 and the battery case 10 each having been in the atmospheric pressure state, to create vacuum in the interior of the vacuum chamber 140 and the interior of the battery case 10. Since the internal space of the battery case 10 communicates with the internal space of the vacuum chamber 140 through the liquid inlet 14, this evacuating the vacuum chamber 140 will simultaneously evacuate the battery case 10. The operations in steps S25 and S26 correspond to an evacuating step, which is one example of the evacuating in the present disclosure. In the present embodiment, the target vacuum degree is set to 15±5 (kPa abs). During steps S21 to S26, the tip portion 2d of the injection nozzle 2 is kept inserted in the battery case 10 through the liquid inlet 14 of the battery case 10 with the electrode body 20 accommodated therein.

In the present embodiment, meanwhile, before the evacuating step (steps S25 to S26) is performed under atmospheric pressure, the bubble discharging step and the preliminary liquid-injecting step (steps S21 to S24) are performed to eject the electrolyte 15 from the injection nozzle 2, thereby discharging the bubbles 6 sticking to the inner surface 2c of the injection nozzle 2 to the outside of the injection nozzle 2 together with the electrolyte 15 ejected from the injection nozzle 2. Accordingly, the evacuating step can be performed after the bubbles 6 are removed from the inner surface 2c of the injection nozzle 2. Specifically, in the evacuating step, while the injection nozzle 2 from which the bubbles 6 having stuck to the inner surface 2c have been removed remains inserted in the battery case 10 through the liquid inlet 14, the battery case 10 can be vacuumed to vacuum. Consequently, it is possible to “perform the evacuating step without causing the bubbles 6 sticking to the inner surface 2c of the injection nozzle 2 to expand out of the injection nozzle 2 and further rupture, and thus prevent resultant droplets from scattering out of the battery case 10 through the liquid inlet 14 and wetting the inlet circumferential edge portion 10b on the top surface of the battery case 10”.

In step S27, the control unit 160 sets a second liquid feeding pressure as the pressure for feeding the electrolyte 15 from the electrolyte tank 150. In step S28, the control unit 160 transmits a command to the liquid injection valve 155 to open, ejecting the electrolyte 15 from the injection nozzle 2 through the ejection ports 2b. The electrolyte 15 is thus injected into the evacuated battery case 10 at a second injection speed (a second flow rate) corresponding to the second liquid feeding pressure. In the present embodiment, this second injection speed is set to 70 g/min. After opening the liquid injection valve 155 in step S28, the control unit 160 advances to step S29 to monitor output values of the flowmeter 153 and determine whether or not the supplied amount of the electrolyte 15 from the electrolyte tank 150 (hence, the ejected amount of the electrolyte 15 from the injection nozzle 2) in step S28 and subsequent steps reaches a predetermined amount B. In the present embodiment, the predetermined amount B is set to 19±0.5 g.

When it is determined in step S29 that the predetermined amount B is reached (S29: YES), the control unit 160 then closes the liquid injection valve 155 in step S2A, stopping ejection of the electrolyte 15 from the injection nozzle 2. The injection of the electrolyte 15 under vacuum is thus terminated. The operations in steps S27 to S2A correspond to a vacuum-injecting step, which is one example of the vacuum-injecting in the present disclosure. Subsequently, the control unit 160 turns off the vacuum pump 145 in step S2B and opens the air release valve 147 in step S2C. Accordingly, the interior of the vacuum chamber 140 returns to atmospheric pressure and also the interior of the battery case 10 returns to atmospheric pressure.

In the present embodiment, while the injection nozzle 2 inserted in the battery case 10 for the preliminary liquid-injecting step (steps S21 to S24) remains inserted therein, the preliminary liquid-injecting step and the evacuating step (steps S25 to S26) and the vacuum liquid-injecting step (steps S27 to S2A) are continuously performed. Thus, those preliminary liquid-injecting step, evacuating step, and vacuum liquid-injecting step are successively executed without moving the injection nozzle 2 out of the battery case 10 in the middle of the steps, so that those three steps can be performed quickly.

In step S2D, the control unit 160 sets a third liquid feeding pressure as the pressure for feeding the electrolyte 15 from the electrolyte tank 150. In step S2E, the control unit 160 then opens the liquid injection valve 155 to eject the electrolyte 15 from the injection nozzle 2 through the ejection ports 2b. At that time, the injection nozzle 2 remains inserted in the battery case 10. Thus, the electrolyte 15 is injected into the battery case 10 whose interior has been returned to atmospheric pressure, at a third injection speed (a third low rate) corresponding to the third liquid feeding pressure. In the present embodiment, this third injection speed is set to 70 g/min.

After opening the liquid injection valve 155 in step S2E, the control unit 160 advances to step S2F to monitor output values of the flowmeter 153 and determine whether or not the supplied amount of the electrolyte 15 from the electrolyte tank 150 during step S2E and subsequent steps, that is, the ejected amount of the electrolyte 15 from the injection nozzle 2 during step S2E and subsequent steps, reaches a predetermined amount C. In the present embodiment, the predetermined amount C is set to 10±0.5 g.

When it is determined in step S2F that the predetermined amount C is reached (S2F: YES), the control unit 160 advances to step S2G to interrupt liquid injection. Specifically, the control unit 160 closes the liquid injection valve 155 to temporarily stop ejection of the electrolyte 15 from the injection nozzle 2. After a lapse of 800 seconds from the time of closing the liquid injection valve 155, the control unit 160 restarts the liquid injection. Specifically, the control unit 160 opens the liquid injection valve 155, ejecting the electrolyte 15 from the injection nozzle 2 through the ejection ports 2b to inject the electrolyte 15 again at the third injection speed (70 g/min) into the battery case 10 whose internal is at the atmospheric pressure. In step S2G, in other words, the liquid injection at the third injection speed (70 g/min) is interrupted for 800 seconds. This step S2G in which injection of the electrolyte 15 into the battery case 10 whose interior is at the atmospheric pressure is interrupted for 800 seconds allows the electrolyte 15 (the predetermined amount C of electrolyte 15) injected into the battery case 10 so far under the atmospheric pressure to penetrate through the electrode body 20.

In next step S2H, the control unit 160 determines whether or not the supplied amount of the electrolyte 15 from the electrolyte tank 150 (hence, the ejected amount of the electrolyte 15 from the injection nozzle 2) after the liquid injection is interrupted in step S2G and then the liquid injection valve 155 is opened to restart the liquid injection reaches a predetermined amount D. In the present embodiment, the predetermined amount D is set to 9±0.5 g. When it is determined in step S2H that the predetermined amount D is reached (S2H: YES), the control unit 160 closes the liquid injection valve 155 in step S2G to stop ejection of the electrolyte 15 from the injection nozzle 2.

Thus, the injection of the electrolyte 15 under atmospheric pressure is stopped and also the liquid injecting process (step S2) is terminated. In the liquid injecting process (step S2) in the present embodiment, a total of 38±1.0 g of the electrolyte 15 is injected into the battery case 10. After this-time liquid injecting process (step S2) is terminated, the injection nozzle 2 with the electrolyte 15 remaining therein is kept under atmospheric pressure until a next liquid injecting process on another battery case 10 is newly started.

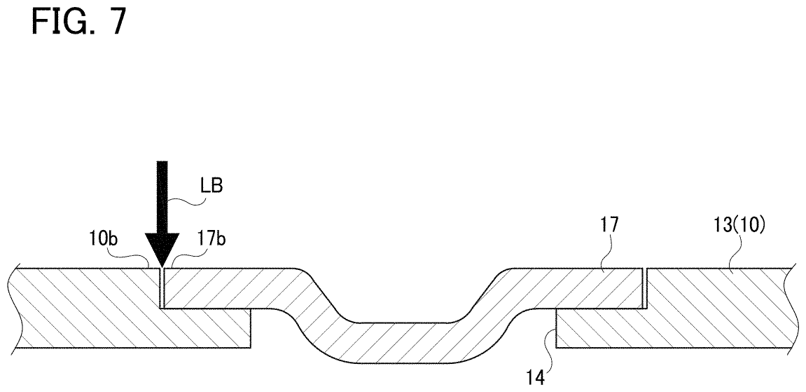

As shown in FIG. 3, in step S3 (Sealing process) after termination of the liquid injecting process (step S2), the sealing member 17 and the lid 13 with the liquid inlet 14 sealed with the sealing member 17 are welded together by laser (see FIG. 7). The liquid inlet 14 is a cylindrical port and the sealing member 17 is a circular member in plan view. Specifically, as shown in FIG. 7, a laser beam LB is irradiated in a linear pattern along the inlet circumferential edge portion 10b of the lid 13 of the battery case 10 and a circumferential edge portion 17b of the sealing member 17, thereby welding the sealing member 17 to the inlet circumferential edge portion 10b of the lid 13. The inlet circumferential edge portion 10b and the circumferential edge 17b each extend annularly in plan view. In the present embodiment, therefore, the sealing member 17 and the inlet circumferential edge portion 10b are welded together in an annular pattern over their entire circumference by the laser beam LB. Thereafter, the battery 1 is subjected to initial charging and others, and thus completed.

In step S3 (Sealing process), if the inlet circumferential edge portion 10b on the top surface of the lid 13 is wet with the electrolyte 15, the sealing member 17 and the inlet circumferential edge portion 10b may be poorly welded, and thus the liquid inlet 14 may not be sealed tightly. In contrast, in the present embodiment, as described above, before execution of the evacuating step (steps S25 to S26), under atmospheric pressure, the bubble discharging step and the preliminary liquid-injecting step (steps S21 to S24) are performed. Consequently, it is possible to “perform the evacuating step without causing the bubbles 6 sticking to the inner surface 2c of the injection nozzle 2 to expand out of the injection nozzle 2 and further rupture, and thus prevent resultant droplets from scattering out of the battery case 10 through the liquid inlet 14 and wetting the inlet circumferential edge portion 10b on the top surface of the battery case 10”. Accordingly, the sealing member 17 and the inlet circumferential edge portion 10b can be appropriately welded to each other, so that the liquid inlet 14 can be reliably sealed with the sealing member 17.

The present disclosure is described above in the embodiments but not limited thereto. The present disclosure may be embodied in other specific forms without departing from the essential characteristics thereof.

For example, in the above embodiment, as the bubble discharging step (S21 to S24), the preliminary liquid-injecting step is performed to inject the electrolyte 15 together with the bubbles 6 into the battery case 10. As an alternative, the bubble discharging step may be performed to discharge the electrolyte 15 together with the bubbles 6 without injecting them into the battery case 10. In this case, the vacuum chamber 140 may be provided with an outlet port (not shown) for discharging the electrolyte 15 so that the bubbles 6 and the electrolyte 15 are injected into that outlet port in the bubble discharging step.

### REFERENCE SIGNS LIST

1 Battery
2 Injection nozzle
2b Ejection port
6 Bubbles
10 Battery case
14 Liquid inlet
15 Electrolyte
17 Sealing member
20 Electrode body
100 Liquid injection device
140 Vacuum chamber
150 Electrolyte tank

What is claimed is:

1. A method for producing a battery provided with an electrode body and an electrolyte which are accommodated in a battery case, the method comprising:
evacuating the battery case whose interior is at atmospheric pressure to create vacuum in the battery case accommodating the electrode body while a liquid injection nozzle is inserted in the battery case through a liquid inlet of the battery case; and
vacuum-injecting the electrolyte into the battery case whose interior has been evacuated to the vacuum, by ejecting the electrolyte from the injection nozzle,
wherein the method further comprises:
under atmospheric pressure before the evacuating is performed,
discharging bubbles, which stick to an inner surface of the injection nozzle, to outside of the injection nozzle together with an electrolyte ejected from the injection nozzle by ejecting the electrolyte from the injection nozzle.

2. The method for producing a battery according to claim 1, wherein the discharging includes preliminarily injecting the electrolyte together with the bubbles into the battery case by ejecting the electrolyte from the injection nozzle while the injection nozzle is inserted, through the liquid inlet, in the battery case whose interior is at the atmospheric pressure.

3. The method for producing a battery according to claim 2, wherein the preliminarily injecting, the evacuating, and the vacuum-injecting are continuously performed while the injection nozzle inserted in the battery case for the preliminarily injecting is kept inserted in the battery case.
